(19) United States
(12) Patent Application Publication
(10) Pub. No.: US 2009/0296541 A1
(43) Pub. Date: Dec. 3, 2009

(54) Library apparatus and method for delivering storage media in library apparatus

(75) Inventor: Koujiro Hashimoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/385,459

(22) Filed: Apr. 8, 2009

(30) Foreign Application Priority Data
Jun. 2, 2008 (JP) 2008-145024

(51) Int. Cl. G11B 21/08

(52) U.S. Cl. 369/36.01; G9B/21.012

(57) ABSTRACT

A library apparatus includes: a support body; a media container rack rotatable around a horizontally extending rotation shaft and having cells radially arranged to respectively contain removable storage media in a horizontal direction; a media drive fixed to the support body and accessing a storage medium loaded therein; and a media delivery device that delivers the storage media between the media container rack and the media drive. The apparatus further includes: a guide member that guides the media delivery device; and a controller which controls the media drive and rotation of the media container. The controller causes the guide member to guide the media delivery device and rotates the media container rack so as to set the target cell at a position where the media delivery device guided by the guide member can take and put one of the storage media out of and back in a target cell.

### CROSS-REFERENCE TO RELATED APPLICATION

This application is based upon and claims the benefit of priority of the prior Japanese Patent Application No. 2008-145024, filed on Jun. 2, 2008, the entire contents of which are incorporated herein by reference.

### FIELD

The embodiment discussed herein is related to a library apparatus and a method for delivering storage media in the library apparatus.

### BACKGROUND

With the development of information techniques in recent years, the techniques related to storage media for storing therein information in the form of electronic data have also been developed rapidly. Among the storage media, large-capacity storage media such as magneto-optical discs or magnetic tapes are often used for data backup because of high storage capacities thereof. In particular, data generated for backup (backup data) reaches an enormous amount when the data backup is carried out continuously for ever-changing information such as bank or stock transaction information. In such a case, it is a general practice to write the backup data into multiple large-capacity storage media, and to store the storage media after writing the backup data therein. Here, a library apparatus has heretofore been known as an apparatus which is suitable for managing such a large amount of backup data.

A library apparatus includes a container rack for containing multiple storage media, a drive for accessing (writing data in and reading data out of) the storage media, and a robot for delivering the storage media between the container rack and the drive. The library apparatus is capable of taking a desired storage medium out of the container rack and mounting the storage medium into the drive by using the robot, and then returning, to the container rack, the storage medium after the access by using the robot. In this way, the library apparatus writes a large amount of backup data into the storage media one by one and sequentially stores the storage media in the container rack. Accordingly, the library apparatus can manage the large amount of backup data efficiently.

Now, a conventional library apparatus will be described more concretely.

FIG. 1 is an external perspective view of a conventional library apparatus 100′.

As illustrated in FIG. 1, the conventional library apparatus 100′ includes arrays of multiple cells 1′ each containing a storage medium. The container rack is formed of the arrays of the cells 1′. The library apparatus 100′ includes drives 2 for accessing the storage media and a robot 3′ for delivering the storage media between the cells 1′ and the drives 2.

FIG. 2 is a view illustrating the cells 1′, the drive 2, and the robot 3′ in a plane extending in a horizontal direction of FIG. 1, and FIG. 3 is a view illustrating the drives 2 and the robot 3′ in a plane extending in vertical and depth directions of FIG. 1.

Each of the cells 1′ includes a container space that can contain a single storage medium 20. FIG. 2 illustrates a state in which the storage media 20 are respectively contained in five out of six cells 1′. The drive 2 includes a loader 2A which is opened to the outside of the drive 2 for loading the storage medium 20 thereon, and accesses the storage medium 20 loaded on this loader 2A. The robot 3′ includes a hand section 14′ and a hand support member 16′. Hereinbelow, the hand section 14′ and the hand support member 16′ will be described.

The hand section 14′ has the functions of: conveying the storage media 20 between the cells 1′ and the drives 2; taking the storage media 20 out of the cells 1′; loading the storage media 20 into the cells 1′; taking the storage media 20 out of the drives 2, and loading the storage media 20 into the drives 2. The hand section 14′ includes a storage section 14A′ for storing the storage medium 20 which is opened to the outside of the hand section 14′. Moreover, the hand section 14′ is capable of orienting the aperture of the storage section 14A′ in a desired direction by rotating around a rotation center O′ in directions of the arrows B′ in FIG. 2. Meanwhile, the hand section 14′ is capable of freely traveling on the hand support member 16′ having an elongated shape extending in the lengthwise direction of FIG. 2 in directions indicated by the arrows A′ in FIG. 2. Driven by the rotation mechanism and the motion mechanism of the hand section 14′, the hand section 14′ comes close to one of the cells 1′ around the hand support member 16′ or to the drive 2 in the plane illustrated in FIG. 2, orients the aperture of the storage section 14A′ toward the cell 1′ or the drive 2, and delivers the storage media 20 between the cells 1′ and the drive 2.

Meanwhile, driven by an unillustrated mechanism, this hand support member 16′ can move in a perpendicular direction relative to the plane shown in FIG. 2 (the vertical direction of FIG. 1 and FIG. 3) with the hand section 14′ mounted on the hand support member 16′. In FIG. 3, a movable region of this hand support member 16′ is indicated as a movable region 4′ surrounded by the dotted line. As illustrated in FIG. 3, this conventional library apparatus 100′ includes three drives 2 arranged in the vertical direction of FIG. 3 (the vertical direction of FIG. 1), and one of the three drives 2 is illustrated in FIG. 1 and FIG. 2. The hand support member 16′ is capable of travelling in directions of the arrows C′ in FIG. 3 with the hand section 14′ mounted thereon and also capable of moving up to the same height as that of a desired drive 2 out of the three drives 2 arranged in the vertical direction of FIG. 3. In this way, the hand support member 16′ moves up to the height of the targeted drive 2 and then the hand section 14′ travels on the hand support member 16′ to the targeted drive 2. When the hand section 14′ comes close to the targeted drive 2, the hand section 14′ orients the aperture of the storage section 14A toward the drive 2 and then delivers the storage medium 20 to the drive 2. Here, the cells 1′ which are not illustrated in this FIG. 3 are arranged in the vertical direction and the horizontal direction of FIG. 3 (see FIG. 1) at the back side and the front side of the movable region 4′ depicted in FIG. 3. In the horizontal direction, in particular, the cells 1′ are arranged in a similar layout as illustrated in FIG. 2. As the hand support member 16′ moves, the hand section 14′ can come close to these cells 1′ and deliver the storage media 20 in a similar manner to the description with FIG. 2. Note that a controller 7 for controlling the robot 3′ and accesses of the drives 2 in this conventional library apparatus 100′ is also shown in FIG. 3.

In the conventional library apparatus, as the hand section 14′ in the robot 3′ travels as described above, a desired storage medium is taken out of the cell 1′ containing the storage medium, carried to the drive 2, mounted in the drive 2, and accessed by the drive 2. Then, after accessed, the storage medium is carried to the cell 1′ and stored in the cell 1′ again. The conventional techniques are disclosed in Japanese Patent Application Publications No. 07-14289 and No. 06-36433, for example.

In recent years, in the field of the library apparatuses, there is a growing demand for a library apparatus that can store a large amount of information without requiring the apparatus to have a large volume. Accordingly, a high-density layout of the cells and the drives need to be devised so that more storage media can be stored within limited apparatus volume.

Nevertheless, the conventional library apparatus 100′ illustrated in FIGS. 1 to 3 includes a lot of spaces inside the apparatus which are not usable for locating the cells or drives. Therefore, it is difficult to achieve the high-density layout as described previously.

For example, in the conventional library apparatus 100′, a space 5 on an upper left part and a space 5 on an upper right part in the library apparatus 100′ are regions where the hand section 147 cannot approach as illustrated in FIG. 2, so that it is not possible to dispose the cells 1′ and the drives 2 in these regions.

Meanwhile, in the conventional library apparatus 100′, the hand support member 16′ is formed into the elongated shape extending in the horizontal direction as depicted in FIG. 3. Accordingly, as illustrated in FIG. 3, the hand support member 16′ has the considerably wide movable region 4′. The cells 1′ or the drives 2 cannot be disposed in this movable region 4′, either.

Accordingly, it is hard to dispose the cells 1′ and the drives 2 in a high-density layout in the conventional library apparatus 100′. Therefore, it is difficult to achieve a library apparatus capable of storing a large amount of information while avoiding increase in size.

### SUMMARY

According to an aspect of the invention, a library apparatus includes:

a support body;

a media container rack shaped like a plate, the media container rack being rotatable around a horizontally extending rotation shaft and having a plurality of cells radially arranged to respectively contain a plurality of storage media that are removable in a horizontal direction parallel to the rotation shaft;

a media drive fixed to the support body, the media drive allowing any one of the storage media to be loaded therein and accessing the loaded storage medium that is unloadable;

a media delivery device which delivers the storage media between the media container rack and the media drive;

a guide member which is fixed to the support body and guides the media delivery device along the media container rack; and

a controller which controls the media drive and rotation of the media container rack so as to cause the media delivery device to deliver the storage media between the media container rack and the media drive,

wherein, the controller causes the guide member to guide the media delivery device and rotates the media container rack so as to set the delivery target cell at a position where the media delivery device guided by the guide member delivers the storage medium such that the storage medium can be taken out of and put back in the delivery target cell.

According to another aspect of the invention, a library apparatus includes:

a support body;

a media container rack shaped like a plate, the media container rack being rotatable around a horizontally extending rotation shaft and having a plurality of cells radially arranged to respectively contain a plurality of storage media that are removable in a horizontal direction parallel to the rotation shaft;

a media drive fixed to the support body, the media drive allowing any one of the storage media to be loaded therein and accessing the loaded storage medium that is unloadable;

a media delivery device which delivers the storage media between the media container rack and the media drive; and

a guide member which is fixed to the support body and guides the media delivery device along the media container rack.

According to another aspect of the invention, a method of delivering a storage medium between a media storage rack and a media drive in a library apparatus including:

a support body;

a media container rack shaped like a plate, the media container rack being rotatable around a horizontally extending rotation shaft and having a plurality of cells radially arranged to respectively contain a plurality of storage media that are removable in a horizontal direction parallel to the rotation shaft;

a media drive fixed to the support body, the media drive allowing any one of the storage media to be loaded therein and accessing the loaded storage medium that is unloadable;

a media delivery device which delivers the storage media between the media container rack and the media drive; and

a guide member which is fixed to the support body and guides the media delivery device along the media container rack, and

the method includes:

causing the guide member to guide the media delivery device, when taking out any one of the storage media contained in a current delivery target cell among the plurality of cells from the current delivery target cell, and putting the storage medium taken out of the media drive back in the delivery target cell that is empty;

rotating the media container rack so as to set the delivery target cell at a position where the media delivery device carries out delivery; and

causing the media delivery device to take the storage medium out of the delivery target cell and to put the storage medium back in the delivery target cell, in a direction along which the rotation shaft of the media container rack extends.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an external perspective view of a conventional library apparatus;

FIG. 2 is a view illustrating cells, a drive, and a robot on a plane extending in a horizontal direction of FIG. 1;

FIG. 3 is a view illustrating the cells, the drives, and the robot on planes extending in two directions of a vertical direction of FIG. 1 and a depth direction of FIG. 1;

FIG. 4 is an external perspective view of a library apparatus representing an embodiment;

FIG. 5 is another external perspective view of the library apparatus representing the embodiment;

FIG. 6 is a view representing a cell illustrated in FIG. 4 and FIG. 5;

FIG. 7 is a view illustrating a disc-type container rack;

FIG. 8 is a view illustrating layouts of a hand section and a movable plate while removing the disc-type container rack located on a front side;

FIG. 9 is a view illustrating cells, a drive, and a robot on a plane extending in a horizontal direction of FIG. 8 in a state where a position of the movable plate is located in the same position as a guide plate in FIG. 8;

FIGS. 10A and 10B are views illustrating a stacked-type container rack, the drives, and the robot on planes extending in two directions of the vertical direction of FIG. 8 and the depth direction of FIG. 8;

FIG. 11 is a view illustrating a rotation mechanism of the disc-type container rack;

FIGS. 12A and 12B are views illustrating a motion mechanism of the hand section on the guide plate;

FIG. 13 is a view illustrating a rotation mechanism of the hand section; and

FIGS. 14A and 14B are views illustrating a motion mechanism of the movable plate.

### DESCRIPTION OF EMBODIMENT

An embodiment of the library apparatus will be described below with reference to the accompanying drawings.

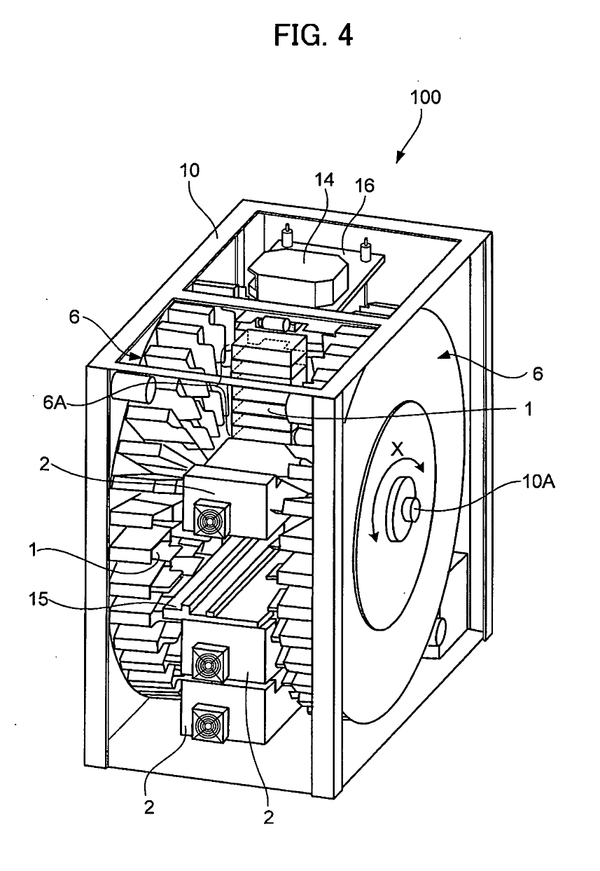

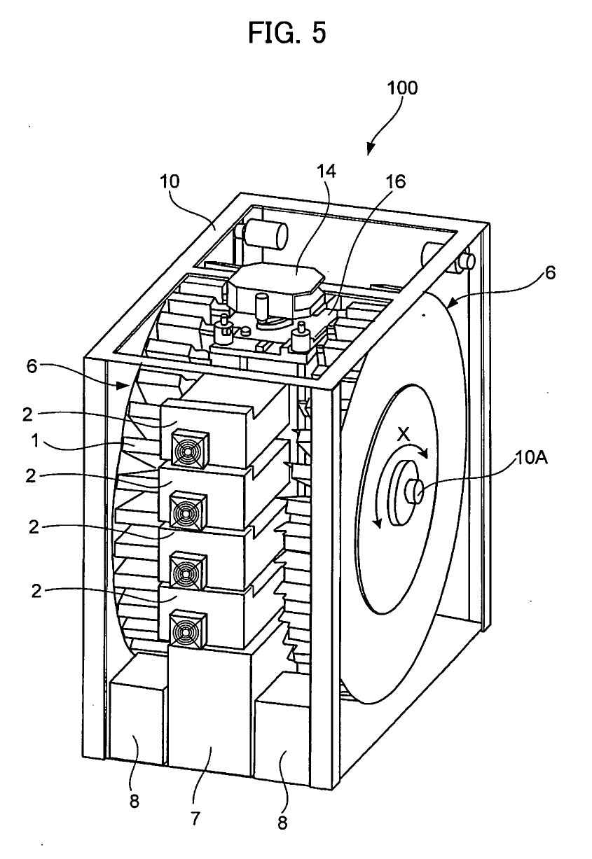

FIG. 4 and FIG. 5 are external perspective views of a library apparatus 100 which represents an embodiment of the invention.

FIG. 4 is the external perspective view of the library apparatus 100 viewed from a front side, and the FIG. 5 is the external perspective view of the library apparatus 100 viewed from a rear side.

As illustrated in FIG. 4 and FIG. 5, the library apparatus 100 includes two container racks 6 having an overall shape of a disc (hereinafter referred to as “disc-type container racks”) which have multiple radially arranged cells 1 respectively containing storage media. These two disc-type container racks 6 are supported by a support bar 10A inserted into a disc center and are rotated in directions of the arrows X in FIG. 4 by way of a rotation mechanism to be described later. This support bar 10A is fixed to a housing 10 which forms an external shell of the library apparatus 100. The housing 10 is the member that entirely covers the library apparatus 100. However, only the skeleton of the housing 10 (edge sections of the housing 10 of a rectangular solid shape) is depicted in FIG. 4 and FIG. 5 in order to clearly illustrate the internal structure of the library apparatus 100. In this context, illustration of the housing 10 that covers side surfaces and an upper surface of the library apparatus 100 is omitted. The support bar 10A is fixed to the unillustrated sections of the housing on the side surfaces.

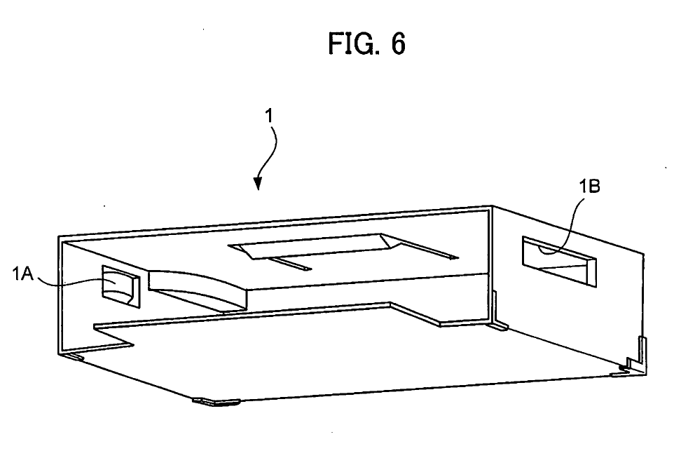

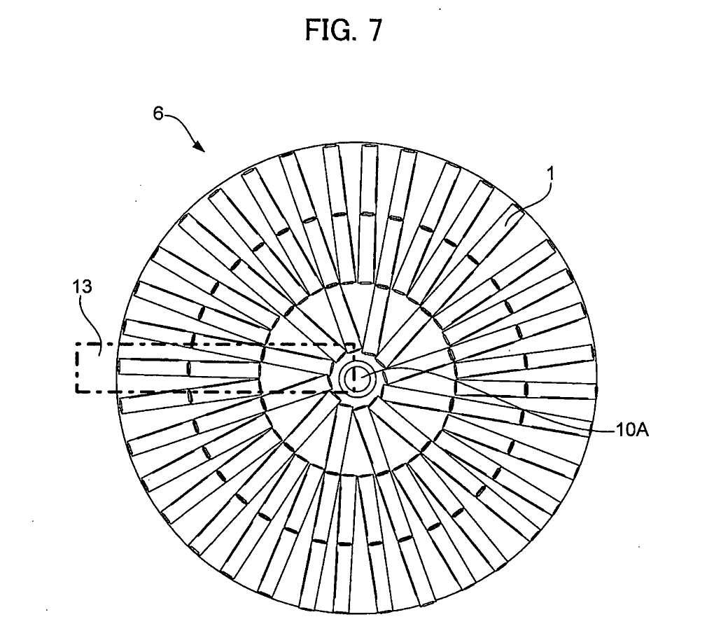

FIG. 6 is a view illustrating a cell 1 which is depicted in FIG. 4 and FIG. 5, and FIG. 7 is a view illustrating the disc-type container rack 6.

As illustrated in FIG. 6, the cell 1 has a container space inside which is sufficient for containing a storage medium. A storage medium is loaded in this container space. As illustrated in FIG. 6, the cell 1 includes a fitting member 1A and a fitting aperture 1B which are provided on an inner sidewall. In the disc-type container rack 6 illustrated in FIG. 7, the radially arranged cells 1 are connected to one another so as to fit the fitting member 1A on one of the cells 1 into the fitting aperture 1B on the adjacent cell 1.

The disc-type container rack 6 corresponds to an example of the media container rack, and a combination of the housing 10 and the support bar 10A corresponds to an example of the support.

Reference will be made to FIG. 4 again to continue the explanation.

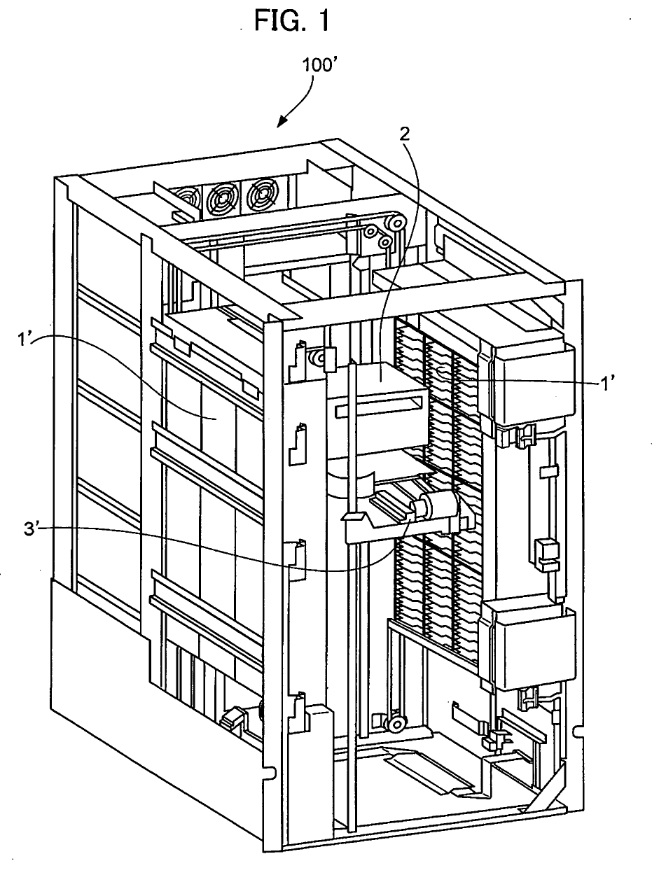

As illustrated in FIG. 4, on the front face side of the two disc-type container racks 6, two drives 2, a guide plate 15, another drive 2, and a stacked-type container rack 6A are arranged from a lower side in FIG. 4 in the enumerated order. The drives 2 are the same as the drive described with reference to FIGS. 1 to 3. When a storage medium 20 is loaded into a loader 2A opened on the outside of the drive 2, the drive 2 carries out access to the storage medium 20. The guide plate 15 is a member for guiding a hand section 14 to be described later in a direction to link a front side with a back side in FIG. 4 and FIG. 5. This guide plate 15 extends in a radial direction of the disc-type container rack 6. Meanwhile, the stacked-type container rack 6A is the rack formed by stacking the cells 1 as illustrated in FIG. 6, and multiple storage media are loaded in the respective cells 1 as similar to the disc-type container rack 6.

Moreover, as illustrated in FIG. 5, a controller 7 and four drives 2 are arranged from a lower side in FIG. 5 in the enumerated order. In addition, two power sources 8 are provided at both sides of the controller 7. The controller 7 plays roles of accessing the drives 2 and controlling a robot to be described later, while the power sources 8 play a role of supplying power to sections in the library apparatus 100.

Meanwhile, a hand section 14 and a movable plate 16 are located between the array of the three drives 2, the guide plate 15, and the stacked-type container rack 6A arranged in the vertical direction in FIG. 4, and the array of the four drives 2 and the controller 7 arranged in the vertical direction in FIG. 5.

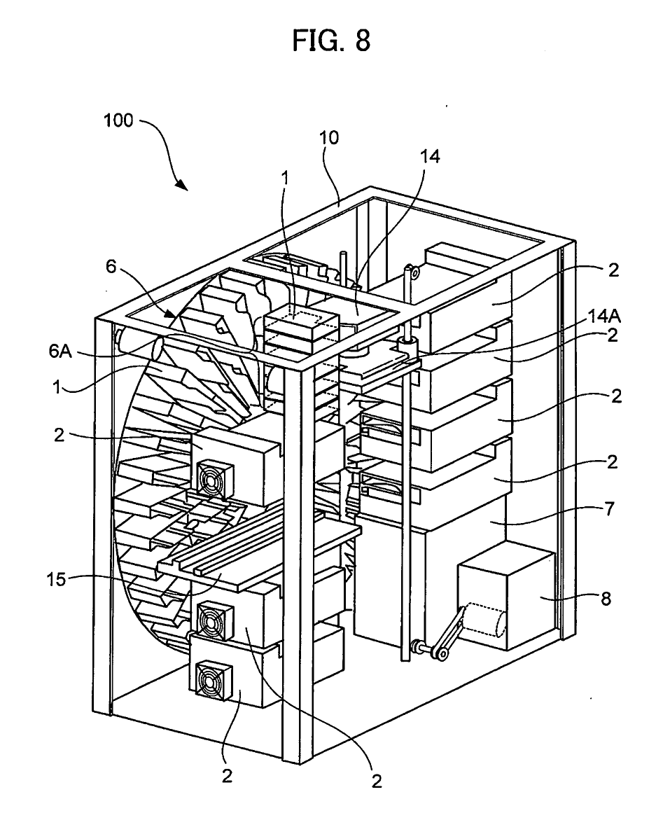

FIG. 8 is a view illustrating layouts of the hand section 14 and the movable plate 16 in a state where the disc-type container rack 6 located on the front side of the FIG. 4 is removed.

The hand section 14 has the functions of: conveying storage media between the drives 2 and the cells 1 in the disc-type container rack 6 and in the stacked-type container rack 6A; taking the storage media out of the cells 1; storing the storage media into the cells 1; taking the storage media out of the drives 2; and loading the storage media into the drives 2. Driven by a motion mechanism to be described later, the movable plate 16 can move in a space in the vertical direction while supporting the hand section 14 thereon. Specifically, the space in which the movable plate 16 can move is formed between: the vertical array of the three drives 2, the guide plate 15 and the stacked-type container rack 6A placed on the front side of FIG. 8; and the vertical array of the four drives 2 and the controller 7 placed on the back side in FIG. 8. In this state, when the position (the level in the vertical direction) of the movable plate 16 is at the same position (the same level) as the guide plate 15 in FIG. 8, the hand section 14 can move away from the movable plate 16 and to travel onto the guide plate 15. The guide plate 15, the movable plate 16, and the hand section 14 are elements of the robot for delivering the storage medium between the cell 1 and the drive 2.

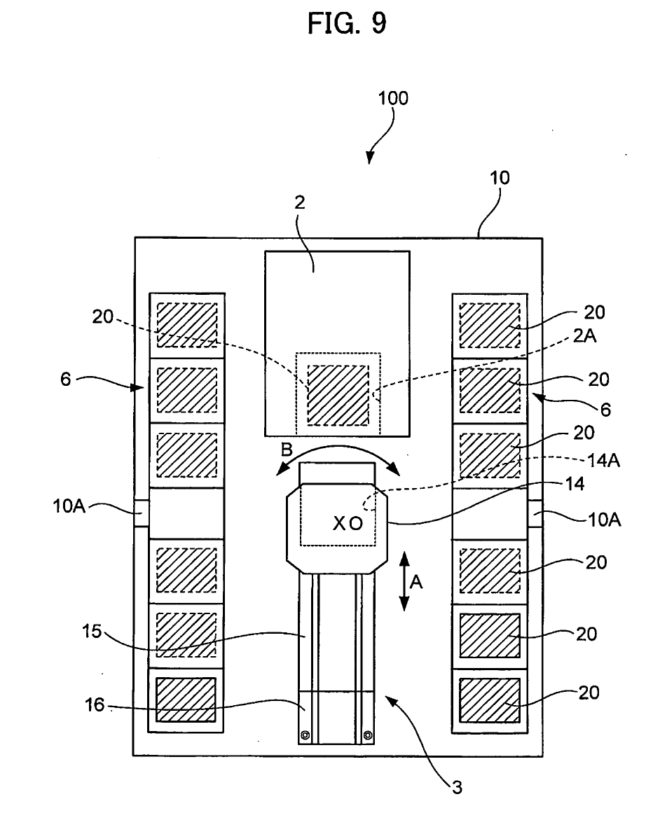

FIG. 9 is a view illustrating the cells 1, the drive 2, and a robot 3 on a plane extending in a horizontal direction of FIG. 8 in a state where the position (the level in the vertical direction) of the movable plate 16 is at the same position (on the same level) as the guide plate 15 in FIG. 8.

As illustrated in FIG. 9, when the position of the movable plate 16 is at the same position as the guide plate 15 in FIG. 8, the combination of the movable plate 16 and the guide plate 15 extends from the place in the vicinity of the rotation centers of the disc-type container racks 6 to the vicinity of peripheries of the disc-type container racks 6 along the two disc-type container racks 6 in the radial direction. FIG. 7 illustrates a region to be occupied by the combined movable plate 16 and the guide plate 15 in the state of FIG. 9, as a region 13 surrounded by a dashed line and overlapped with the disc-type container rack 6. In this state, as the disc-type container rack 6 is rotated around the support bar 10A, the desired cell 1 in the two disc-type container racks 6 comes close to the combined movable plate 16 and the guide plate 15.

Here, the hand section 14 being one of the elements of the robot 3 includes a storage section 14A for storing the storage medium 20. This storage section 14A is opened to the outside of the hand section 14. The hand section 14 is capable of orienting the aperture of the storage section 14A toward a desired direction by rotation around a rotation center O′ in directions of the arrows B′ in FIG. 9 by use of the rotation mechanism to be described later. Moreover, the hand section 14 is capable of freely traveling on the guide plate 15 in directions indicated with the arrows A in FIG. 9 by use of a motion mechanism to be described later. By the rotation mechanism and the motion mechanism of the hand section 14, the hand section 14 comes close to the cell 1 located along the movable plate 16 and the guide plate 15 or to the drives 2 in the vicinity of the guide plate 15, orients the aperture of the storage section 14A thereto, and then carries out delivery of the storage media 20 therebetween.

As described above, in the library apparatus 100, the movable plate 16 moves to the same level as the guide plate 15, the desired cell 1 in the disc-type container rack 6 comes close to the movable plate 16 and the guide plate 15 by rotation of the disc-type container rack 6, and the hand section 14 travels on the guide plate 15 as appropriate. Thereby, the hand section 14 can come close to the desired cell 1. Then, delivery of the storage medium 20 is carried out in such a state where the hand section 14 comes close to the desired cell 1.

Here, the combination of the plate 16 and the guide plate 15 corresponds to an example of the guide member; the hand section 14 corresponds to an example of the media delivery device; and the controller 7 corresponds to an example of the control section.

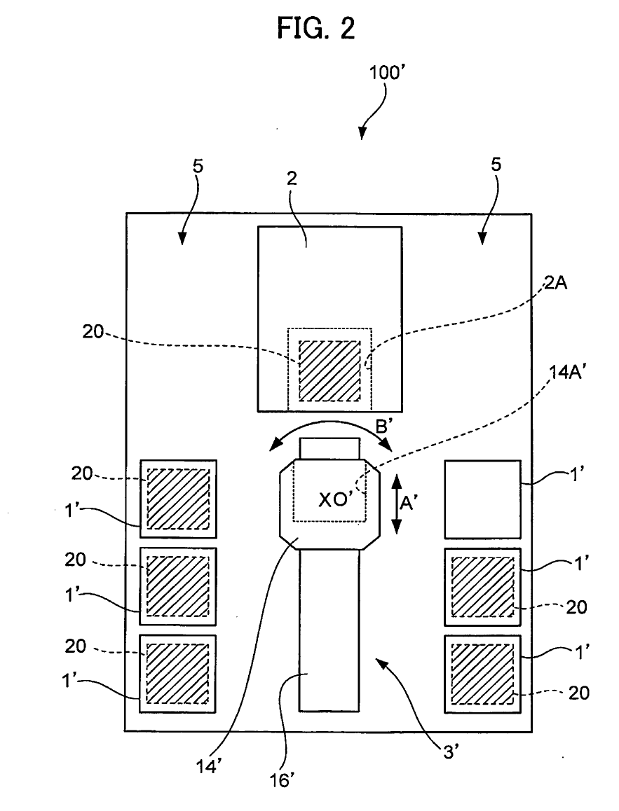

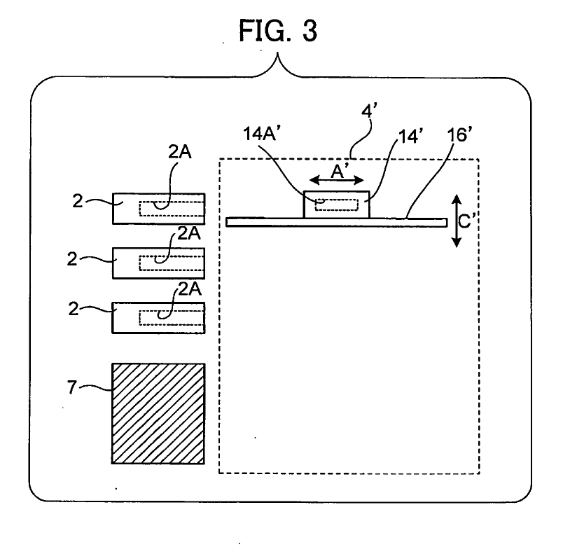

As described above, in the library apparatus 100, delivery of the storage medium 20 between the hand section 14 and the delivery target cell is carried out by rotating the disc-type container rack 6 instead of moving the guide plate 15. In this method, as illustrated as the layouts of the cells land the drives 2 in FIG. 9, there are no unnecessary spaces such as the spaces 5 in the layout illustrated in FIG. 2. For this reason, the cells 1 and the drives 2 are arranged in a higher-density layout than that illustrated in FIG. 2. Moreover, in this library apparatus 100, since the guide plate 15 does not have to move, it is not necessary to secure a large space such as the movable region 4′ for the hand support member 16′ in FIG. 3. Accordingly, the stacked-type container rack 6A and the drives 2 other than the drives 2 in FIG. 9 can be disposed along the disc-type container racks 6 as illustrated in FIG. 8. As a result, this library apparatus 100 implements a library apparatus capable of storing a large amount of information while avoiding increase in size.

Next, description will be given of a manner in which the hand section 14 comes close to the drivers 2 other than the drives 2 in FIG. 9 and to the stacked-type container rack 6A arranged in the vertical direction of FIG. 8 by way of motion of the movable plate 16.

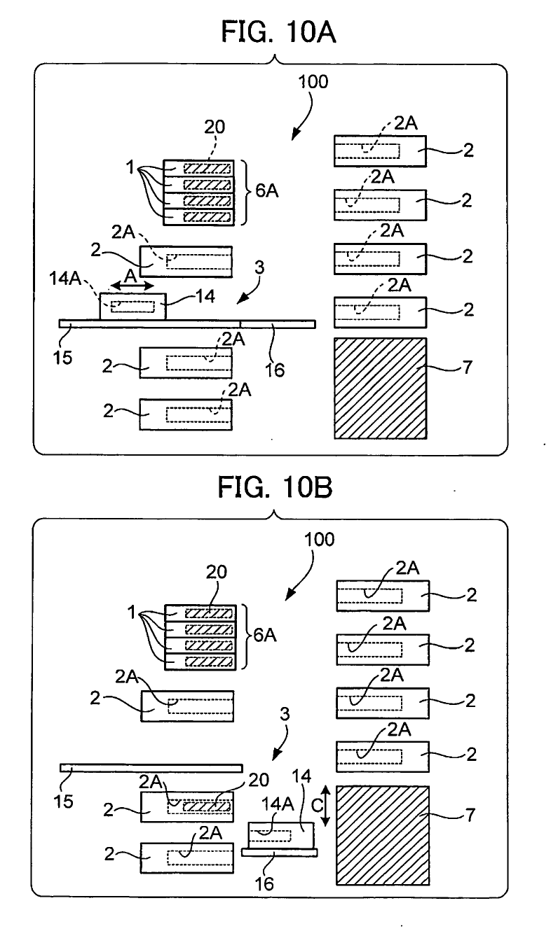

FIGS. 10A and 10B are views illustrating the stacked-type container rack 6A, the drives 2, and the robot 3 on planes extending in two directions of the vertical direction and the depth direction of FIG. 8.

FIG. 10A depicts a state where the movable plate 16 is located on the same level as the guide plate 15, while FIG. 10B depicts a state where the movable plate 16 accompanied by the hand section 14 is located away from the guide plate 15.

In the state illustrated in FIG. 10A, the hand section 14 can deliver the storage medium 20 from or to any one of the cells 1 of the two disc-type container racks 6 only and from or to the lowest drive 2 out of the four drives 2 on the right side of FIG. 10A. As described previously, the movable plate 16 can move in directions indicated with the arrows C in FIG. 10B together with the hand section 14. Thereby, the movable plate 16 comes close to three other drives 2 on the right side in FIG. 10B, the two drives 2 located below the guide plate 15 on the left side in FIG. 10B, the drive 2 located above the guide plate 15, and any of the cells 1 of the stacked-type container rack 6A, besides any of the cells 1 of the disc-type container racks 6 and the lowest drive 2 on the right side, and then carries out delivery of the storage medium 20 from or to any of these elements.

Accordingly, in this library apparatus 100, the storage media 20 are also delivered from or to the stacked-type container rack 6A and the drives 2 located at different levels from the guide plate 15, thereby the space between the two disc-type container racks 6 is effectively utilized. In this library apparatus 100, only the movable plate 16 moves instead of the guide plate 15. Therefore, the region to be secured for a traveling passage of the movable plate 16 becomes reasonably smaller than the movable region 4′ for the hand support member 16′ in FIG. 3.

The rotation mechanism of the disc-type container rack 6, the motion mechanism of the hand section 14 on the guide plate 15, the rotation mechanism of the hand section 14, and the motion mechanism of the movable plate 16 will be described below.

First, the rotation mechanism of the disc-type container rack 6 will be described.

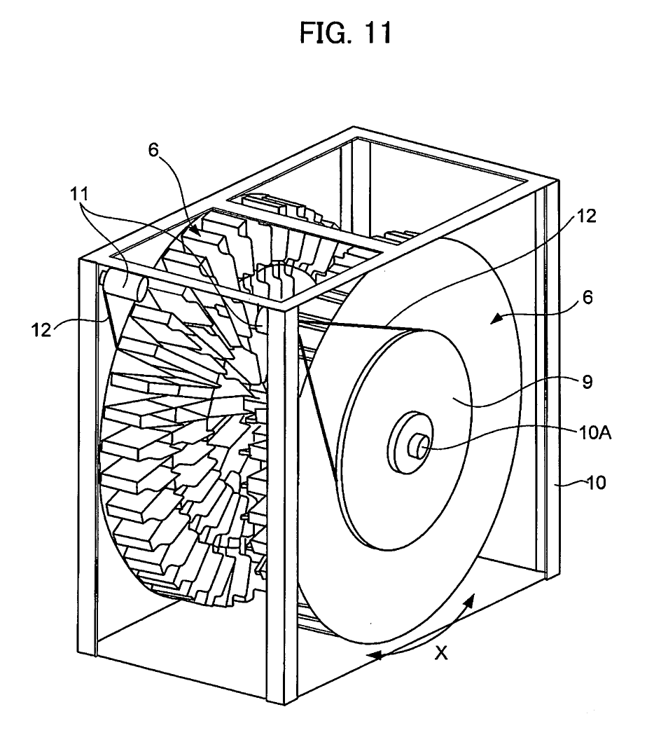

FIG. 11 is a view illustrating the rotation mechanism of the disc-type container rack 6.

As illustrated in FIG. 11, on an upper part of the library apparatus 100, two cell rotation motors 11 are attached to the housing 10 and cell rotation belts 12 are stretched around rotating sections of the respective cell rotation motors 11. Moreover, the cell rotation belts 12 are stretched around cell rotation pulleys 9. Accordingly, when the rotating sections of the cell rotation motors 11 are rotated, the cell rotation belts 12 are driven by the rotation thereby the cell rotation pulleys 9 are rotated. The cell rotation pulleys 9 are integrated with the disc-type container racks 6 so that the disc-type container racks 6 are rotated along with rotation of the cell rotation pulleys 9. The two cell rotation motors 11 are controlled by the controller 7, and the controller 7 rotates the cell rotation motor 11 assigned to rotate the disc-type container rack 6 including a desired cell 1, and then locates the desired cell 1 in the position along the guide plate 15 and the movable plate 16 as illustrated in FIG. 9.

Next, the motion mechanism of the hand section 14 on the guide plate 15 will be described.

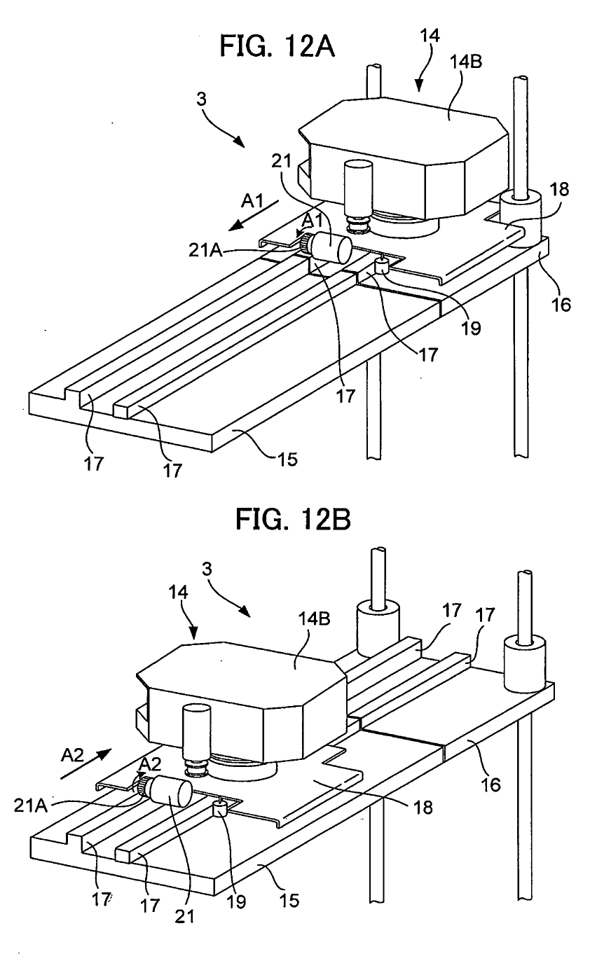

FIGS. 12A and 12B are views illustrating the motion mechanism of the hand section 14 on the guide plate 15.

FIG. 12A depicts a state immediately after the movable plate 16 moves to the same level as the guide plate 15, while FIG. 12B depicts a state after the hand section 14 moves from the movable plate 16 to the guide plate 15.

As illustrated in FIG. 12A, the hand section 14 includes a hand main body 14B, a hand base 18, a roller 19, and a hand section motion motor 21. The hand main body 14B includes the storage section 14A described with reference to FIG. 9, and plays a role of delivering the storage medium 20 from the cell 1 or to the drive 2. The hand base 18 is a member that supports the hand main body 14B, and the roller 19 and the hand section motion motor 21 are connected to the hand base 18. Two rails 17 are respectively provided on the movable plate 16 and the guide plate 15. When the movable plate 16 reaches the same level as the guide plate 15, the two rails 17 on the movable plate 16 are connected to the two rails 17 on the guide plate 15 to form continuous rails 17 as illustrated in FIG. 12A and FIG. 12B. A rotating section 21A of the hand section motion motor 21 contacts one of the two rails 17 and the roller 19 also contacts the rail 17. Note that the hand section 14 includes multiple rollers contacting each of the rails 17. However, FIG. 12A and FIG. 12B illustrate only one roller 19 contacting one of the two rails 17. When the rotating section 21A of the hand section motion motor 21 is rotated in a direction of the arrow A1 in FIG. 12A, the hand base 18 and the hand main body 14B thereon move in a direction of the arrow A1 in FIG. 12A by a rotation drive force of the hand section motion motor 21 while rotating the roller 19. The hand section motion motor 21 is controlled by the controller 7 in FIG. 8, and the controller 7 moves the hand section 14 up to a position close to the desired cell 1 or a position close to one of the drives 2 in FIG. 9 and then causes the hand section 14 to carries out delivery of the storage medium 20 at that position. After execution of delivery, the rotating section 21A of the hand section motion motor 21 is rotated in a direction of the arrow A2 in FIG. 12B under control of the controller 7, and the hand base 18 and the hand main body 14B thereon move in a direction of the arrow A2 in FIG. 12B back to the movable plate 16 by way of a rotation drive force of the hand section motion motor 21.

Next, the rotation mechanism of the hand section 14 will be described.

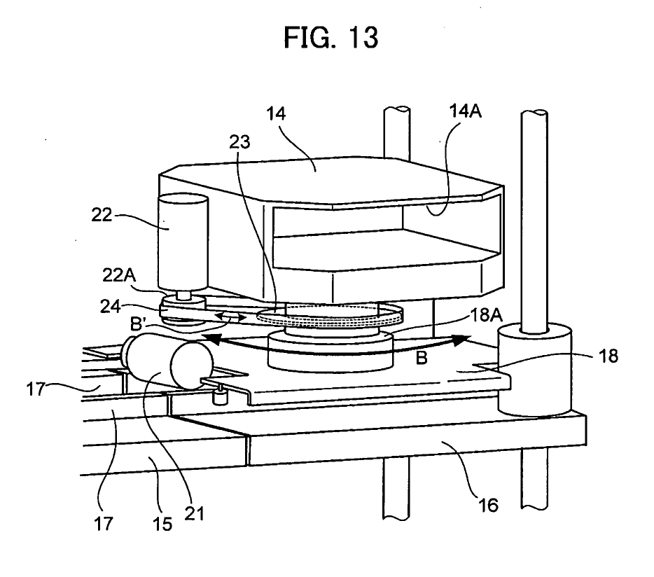

FIG. 13 is a view illustrating the rotation mechanism of the hand section 14.

As illustrated in FIG. 13, in the hand section 14, a hand section rotation motor 22 is fitted to the hand main body 14B and a hand section rotation belt 24 is stretched around a rotating section 22A of this hand section rotation motor 22. Moreover, this hand section rotation belt 24 is stretched around a hand section rotation pulley 23 located below the hand main body 14B. When the rotating section 22A of the hand section rotation motor 22 is rotated, the hand section rotation belt 24 is driven and rotated in directions of the arrows B′ according to the rotating directions of the rotating section 22A, thereby rotating the hand section rotation pulley 23 in directions of the arrows B. Here, the hand main body 14B is fitted so as to rotate in the directions of the arrows B to a connector section 18A on the hand base 18. Meanwhile, the hand section rotation pulley 23 is integrated with the hand main body 14B. Therefore, when the hand section rotation pulley 23 is rotated, the hand main body 14B is also rotated together. Here, the hand section rotation motor 22 is controlled by the controller 7 in FIG. 8, and the controller 7 orients the aperture of the storage section 14A toward a desired cell 1 or drive 2 and carries out delivery of the storage medium 20 thereto.

Next, the motion mechanism of the movable plate 16 will be described.

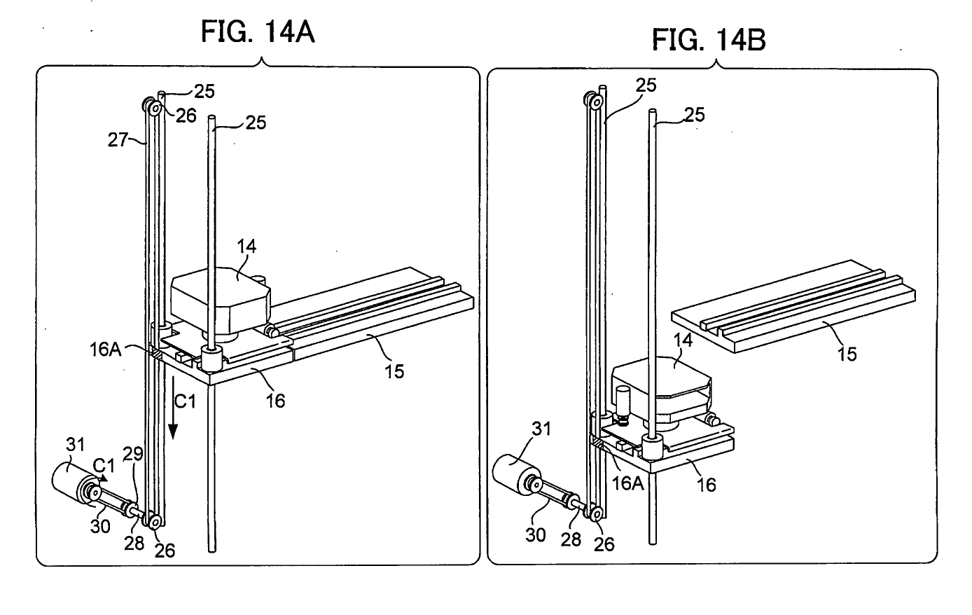

FIGS. 14A and 14B are views illustrating the motion mechanism of the movable plate 16.

FIG. 14A depicts a state where the movable plate 16 is located on the same level as the guide plate 15 like the state illustrated in FIG. 10A, while FIG. 14B depicts a state where the movable plate 16 accompanied by the hand section 14 is located away from the guide plate 15 like the state illustrated in FIG. 10B.

The movable plate 16 is fitted to two guide shafts 25 extending in the vertical direction of FIGS. 14A and 14B so as to be freely movable in the vertical direction. Meanwhile, as illustrated in FIG. 14A, this library apparatus 100 includes a movable plate motion belt 27 located parallel to the guide shafts 25 and wound around two movable plate motion pulleys 26. This movable plate motion belt 27 is partially fixed to a connector section 16A located on a side surface of the movable plate 16. Here, the lower movable plate motion pulley 26 is coaxially integrated with a shaft-side pulley 29 via a shaft 28. Moreover, a shaft-side belt 30 is wound around the shaft-side pulley 29. The shaft-side belt 30 is also wound around a rotating section of a movable plate motion motor 31. For example, when the rotating section of the movable plate motion motor 31 is rotated in a C1 direction in FIG. 14A, the shaft-side belt 30 is driven by the rotation whereby the shaft-side pulley 29, the shaft 28, and the movable plate motion pulleys 26 are rotated. Further, when the movable plate motion belt 27 is driven by this rotation, the movable plate 16 moves in a direction of the arrow C1 in FIG. 14A. As a result, as shown in FIG. 14B, a state is achieved in which the movable plate 16 downwardly moves away from the guide plate together with the hand section 14. Here, when the rotating section of the movable plate motion motor 31 is rotated in the opposite direction to the C1 direction in FIG. 14A, a state is achieved in which the movable plate 16 upwardly moves away from the guide plate 15.

Here, the movable plate motion motor 31 is controlled by the controller 7 in FIG. 8, and the controller 7 moves the hand section 14 to a position close to a desired cell 1 or drive 2, or the guide plate 15.

In the above description, the disc-type container racks 6 have disc shapes. However, the media container racks may have a flat triangular or rectangular shape.

Now, based on the above-described embodiment, some other preferable features that can be added to the library apparatus will be described below.

In the aspect of the library apparatus, it is a preferable aspect to include a second media container rack which is rotatable around the horizontally extending rotation shaft and formed of a plurality of cells radially arranged to respectively contain a plurality of plate-shaped storage media, each cell allowing the medium therein to be freely taken out in a horizontal direction parallel to the rotation shaft, the second media container rack being disposed at a position facing the first media container rack with the guide member interposed in between, wherein the media delivery device takes the storage media out of the first and second media container racks and loads the storage media into the first and second the media container racks.

According to this additional feature, it is possible to contain more storage media by disposing the two media container racks in parallel. Moreover, effective use of the space between the two media container racks is enabled by disposing the cells besides the cells in the media container racks, the media drives, and other necessary devices and members in this space. The library apparatus 100 according to the embodiment includes the two disc-type container racks 6 as illustrated in FIG. 4 and FIG. 5 and thereby achieves the preferable aspect.

Meanwhile, in conjunction with the aspect of the library apparatus, it is also preferable to further include a motion mechanism which causes the media delivery device to deliver and receive the storage media to and from the guide member, and moves the media delivery device in a second direction different from a first direction in which the media delivery device is guided by the guide member, wherein the media drive delivers and receives the storage medium to and from the media delivery device moved by the motion mechanism.

According to this additional feature, by providing the motion mechanism for moving the media delivery device in the second direction, it is possible to allow the media delivery device to carry out reception and delivery of the storage medium to and from the media drive located on the traveling passage of this media delivery device. The library apparatus 100 according to the embodiment includes the seven drives 2 located along the traveling passage of the movable plate 16 extending in the vertical direction of FIG. 10B, and the hand section 14 can receive and deliver the storage media 20 to and from these drives. In this way, the embodiment achieves the preferable additional feature of providing the motion mechanism for moving the media delivery device in the second direction.

According to the aspect firstly described above as the library apparatus, the delivery target cell comes close to the guide member by rotating the media container rack, and then the media delivery device travels on the guide member, so that the media delivery device can come close to a delivery target cell. Here, the guide member does not have to travel, and therefore it is not necessary to secure a space serving as a traveling passage for the guide member. For this reason, cells besides the cells on the media container rack, media drives, and other necessary devices and members can be disposed around the guide member in the direction along the media container rack. As a consequence, according to the present aspect, it is possible to implement the library apparatus capable of preserving a large amount of information while avoiding increase in size.

Further, according to the another aspect described above as the library apparatus as well, the delivery target cell comes close to the guide member by rotating the media container rack, and then the media delivery device travels on the guide member, so that the media delivery device can come close to the delivery target cell. As a consequence, it is possible to implement the library apparatus capable of storing a large amount of information while avoiding increase in size.

Furthermore, according to the another aspect described above as the storage media delivering method, the delivery target cell comes close to the guide member by rotating the media container rack, and then the media delivery device travels on the guide member, so that the media delivery device can come close to the delivery target cell. As a consequence, in the library apparatus, it is possible to store a large amount of information while avoiding increase in size.

Incidentally, the another aspect described above as the storage media delivering method, any of the first step and the second step may be executed earlier or both of the steps may be executed at the same time.

As described above, according to all the aspects described above, it is possible to implement the library apparatus capable of storing a large amount of information while avoiding increase in size.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A library apparatus comprising:
a support body;
a first media container rack being rotatable around a horizontally extending rotation shaft, and having a plurality of radially arranged cells that are removable in a horizontal direction parallel to the rotation shaft, each of the cells is capable of containing a storage media;
a media drive fixed to the support body, the media drive allows any one of the storage media to be loaded therein and accesses the loaded storage medium;
a media delivery device which delivers the storage media between the media container rack and the media drive;
a guide member which is fixed to the support body and guides the media delivery device along the media container rack; and
a controller which controls the media drive and rotation of the media container rack so as to cause the media delivery device to deliver the storage media between the media container rack and the media drive,
wherein, the controller causes the guide member to guide the media delivery device, and rotates the media container rack so as to set the delivery target cell at a position where the storage medium is passed between the media delivery device and the delivery target cell.

2. The library apparatus according to claim 1, further comprises:
a second media container rack being rotatable around the horizontally extending rotation shaft and having a plurality of radially arranged cells that are removable in a horizontal direction parallel to the rotation shaft, each of the cells is capable of containing a storage media respectively, the second media container rack being disposed at a position facing the first media container rack with the guide member interposed in between,
wherein the media delivery device takes the storage media out of and put the storage media back in the first and second media container racks.

3. The library apparatus according to claim 1, further comprising:
a motion mechanism which causes the media delivery device to pass and receive the storage medium to and from the guide member, and moves the media delivery device in a second direction different from a first direction in which the media delivery device is guided by the guide member,
wherein the media drive gives and receives the storage medium to and from the media delivery device moved by the motion mechanism.

4. The library apparatus according claim 2, further comprising:
a motion mechanism which causes the media delivery device to pass and receive the storage medium to and from the guide member, and moves the media delivery device in a second direction different from a first direction in which the media delivery device is guided by the guide member,
wherein the media drive gives and receives the storage medium to and from the media delivery device moved by the motion mechanism.

5. A library apparatus comprising:
a support body;
a media container rack being rotatable around a horizontally extending rotation shaft and having a plurality of radially arranged cells that are removable in a horizontal direction parallel to the rotation shaft, the cells respectively contain a storage media;
a media drive which accesses the storage medium loaded therein;
a media delivery device which delivers the storage media between the media container rack and the media drive; and
a guide member which guides the media delivery device along the media container rack.

6. A method of delivering a storage medium between a delivery target cell of a media storage rack being rotatable around a rotation shaft, the media storage rack having a plurality of radially arranged cells that are capable of containing a storage medium respectively, and a media drive that accesses the storage medium, by a media delivery device that is guided along the media container rack, the method comprising:
guiding a media delivery device to a level of the media container where the delivery target cell exists;
rotating the media container rack so as to set the delivery target cell at a position where the media delivery device carries out delivery of the storage medium; and
taking out the storage medium out of, or putting back the storage medium to the delivery target cell by using the media delivery device.
